(19) United States
(12) Patent Application Publication
(10) Pub. No.: US 2005/0176384 A1
(43) Pub. Date: Aug. 11, 2005

(54) Communication device and communication device ringing method

(75) Inventors: Bunkei Matsuoka, Tokyo (JP); Shinya Takahashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Mitsubishi Denki Kabushiki Kaisha, Tokyo (JP)

(21) Appl. No.: 10/513,334

(22) PCT Filed: Jun. 9, 2003
(86) PCT No.: PCT/JP03/07290

(51) Int. Cl. H04B 1/40

(52) U.S. Cl. 455/84

(57) ABSTRACT

A communication equipment unit producing an incoming call alert sound includes: main incoming call alert signal output means for outputting a main incoming call alert signal for sounding a main incoming call alert sound; advance incoming call alert signal output means for outputting an advance incoming call alert signal for sounding an advance incoming call alert sound; scheduling means for allowing the main incoming call alert signal output means and the advance incoming call alert signal output means to operate so that the main incoming call alert sound is produced after a predetermined period of time elapses since the advance incoming call alert sound is produced; and sound production means reducing the incoming call alert sound based on the main incoming call alert signal and the advance incoming call alert signal.

### TECHNICAL FIELD

The present invention relates to communication equipment units including fixed (wired) telephones, portable telephones, and wireless communication units for institutional use. The invention relates more particularly to communication equipment units and an incoming call alert method for communication equipment units that generate an incoming call alert sound to a user (individual, or a plurality of persons using a terminal) of the communication equipment unit when there is an incoming call from a communication equipment unit requesting communication.

### BACKGROUND ART

For communication between a plurality of communication equipment units, there is used a method for generating an incoming call alert sound for notifying a user of communication equipment unit of an incoming call from another communication equipment unit.

FIG. 1 is a schematic diagram showing an exemplary wireless communication unit disclosed in Japanese Laid-Open Patent Application No. 11-331318.

Referring to FIG. 1, when there is an incoming call, a ringing signal producing circuit 102 produces a ringing signal for generating a ringer sound. An electro-acoustic transducer 101 subjects the ringing signal produced by the ringing signal producing circuit 102 to electro-acoustic transmission so as to generate the ringer sound. A control circuit 104 sets a gain adjusting circuit 103 to a minimum gain and then varies the gain from the minimum level to a normal level over a period between call incoming and off-hook.

Accordingly, even if a user of the wireless communication unit holds a wireless communication unit to the ear when there is an incoming call, the sound pressure of the ringer sound from the electro-acoustic transducer 101 is relatively low since the gain of the gain adjusting circuit 103 is set at a minimum level. The user of the wireless communication unit can successfully hear the ringer sound (incoming call alert sound) of a relatively low sound pressure from the wireless communication unit that the user holds to the ear. With this, the user recognizes the incoming call.

If the user does not hold the wireless communication unit to the ear when there is an incoming call, the sound pressure of the ringer sound is initially relatively low as described above. Since the gain is increased to a normal level by controlling the gain adjusting circuit 103, the electro-acoustic transducer 101 generates the ringer sound with a sound pressure sufficient for hearing. Therefore, the user of the wireless communication unit can successfully hear the ringer sound (incoming call alert sound) of a relatively high sound pressure from the wireless communication unit detached from the ear. With this, the user recognizes the incoming call.

FIG. 2 shows a construction for implementing incoming call sound volume control for a portable telephone set disclosed in Japanese Laid-Open Patent Application No. 5-153201.

Referring to FIG. 2, when an incoming call is detected, an incoming call sound detecting unit 110 detects an incoming call sound generated by an incoming call sound generating unit 105. A counter 111 counts the number of times that the incoming call sound is produced. If the number of times that the incoming call sound is produced is below a level preset in a comparator 112, a switch 107 is connected to terminal “a”. If the number of times exceeds the preset level, the switch 107 is connected to terminal “b”. A fixed attenuator 106 determines the sound volume of the incoming call sound for a situation where the number of times that the incoming call sound is produced is below the preset level. The sound volume determined by the fixed attenuator 106 is relatively small. A variable attenuator 109 determines the sound volume of incoming call sound for a situation where the number of times that the incoming call sound is produced exceeds the preset level.

Accordingly, when the number of times that the incoming call sound detected by the incoming call sound detecting unit 110 is produced is below the preset level, an incoming call sound at a relatively small preset sound volume is produced. When the number of times detected exceeds the preset level, an incoming call sound at a relatively large preset sound volume is produced. With this, the user receiving a call while holding a portable telephone set to the ear recognizes the call by an incoming call sound (incoming call alert sound) at a relatively small sound volume. When the user receives a call while the user is at a noisy place such as a street, the user recognizes the call by an incoming call sound (incoming call alert sound) at a relatively large sound volume for a situation where the preset level is exceeded.

A problem with the related-art incoming call alert using sound in a communication equipment unit is that the sound may be annoying to the user.

Normally, in order to alert the user of an incoming call effectively, the incoming call alert sound is set at a sound quality that is easy to hear and calls immediate attention of the user giving consideration to frequency characteristics and the like. The sound volume of incoming call alert sound may initially be set at a small level so that the incoming call sound at a relatively large, normal sound volume is prevented from being produced when there is an incoming call. However, in the related-art incoming call alert for communication units, the user may still feel uncomfortable as a result of merely changing the sound volume of a single incoming call alert sound, because, with this approach, the user may more or less be surprised at an unexpected incoming call alert sound produced close to the ear.

In recent years, users often use music (melody) as an incoming call alert sound for a communication equipment unit such as a portable telephone set. For example, the music (melody) may be input by the user or downloaded from a provider site.

Here again, the problem according to the related-art incoming call alert using sound in a communication equipment unit is that the only selection available is to set the sound volume of music (incoming call alert sound) at a relatively small level initially and then gradually change it to a normal level, or to set the sound volume at a relatively large, normal level from the beginning.

By selecting incoming call alert in which the sound volume of music is set at a relatively small level initially and then changed gradually to a relatively large, normal level, the user may find initial difficulty in hearing the music. Incoming call alert may be selected such that the sound volume of music is set at a relatively large, normal level from the beginning so that the music can be heard at a relatively large, normal sound volume from the beginning. In this case, the user may feel more or less surprised at an unexpected incoming call alert sound.

Either selection of control cannot satisfy the user. Thus, the related-art incoming call alert using sound in a communication equipment unit may make the user feel uncomfortable when the incoming call alert sound is controlled such that the user can hear it at a relatively large, normal sound volume from the beginning.

The present invention has been developed with a view to resolving the above-mentioned problems and has an objective of providing a communication equipment unit and an incoming call sound alert method for the communication equipment unit capable of reducing discomfort felt when there is an incoming call.

### DISCLOSURE OF THE INVENTION

A communication equipment unit producing an incoming call alert sound according to one aspect of the present invention comprises: main incoming call alert signal output means for outputting a main incoming call alert signal for sounding a main incoming call alert sound; advance incoming call alert signal output means for outputting an advance incoming call alert signal for sounding an advance incoming call alert sound; operation scheduling means for allowing the main incoming call alert signal output means and the advance incoming call alert signal output means to operate so that the main incoming call alert sound is produced after a predetermined period of time elapses since the advance incoming call alert sound is produced; and sound production means reducing the incoming call alert sound based on the main incoming call alert signal and the advance incoming call alert signal.

In accordance with this aspect of the invention, the main incoming call alert sound is produced after a predetermined period of time elapses since the production of the advance incoming call alert sound. Accordingly, the user is capable of recognizing the incoming call when the incoming call alert sound having a sound quality and a sound volume corresponding to the mode of usage is produced. In comparison with a situation where a single incoming call alert sound is produced, discomfort felt by the user is reduced. In further accordance with this aspect, incoming call alert is implemented only by a construction related to sound production. In comparison with a case where an alert is given of an incoming call using vibration and then an incoming call alert sound is produced, the construction for incoming call alert is simplified.

The communication equipment unit according to another aspect of the invention is constructed such that the main incoming call alert signal output means comprises a main incoming call alert signal output unit for outputting the main incoming call alert signal and a main incoming call alert signal gain adjusting unit for adjusting a gain of the main incoming call alert signal, the advance incoming call alert signal output means comprises an advance incoming call alert signal output unit for outputting the advance incoming call alert signal and an advance incoming call alert signal gain adjusting unit for adjusting a gain of the advance incoming call alert signal, and the scheduling means allows the main incoming call alert signal output unit, the main incoming call alert signal gain adjusting unit, the advance incoming call alert signal output unit and the advance incoming call alert signal gain adjusting unit.

In accordance with this aspect of the invention, the sound volume of the main incoming call alert sound and the advance incoming call alert sound is adjusted so as to reduce discomfort felt by the user.

The communication equipment unit according to yet another aspect of the invention is constructed such that the scheduling means allows the advance incoming call alert signal gain adjusting unit to operate such that the advance incoming call alert sound is produced at a relatively small volume.

In accordance with this aspect of the invention, an incoming call alert signal is prevented from being abruptly produced at a large sound volume, thereby reducing discomfort felt by the user.

The communication equipment unit according to yet another aspect of the invention is constructed such that the sound producing means comprises a sound generator for producing an incoming call alert sound, a mixing unit for superimposing the main incoming call alert signal and the advance incoming call alert signal upon each other so as to output an incoming call alert signal, and a sound generator driving unit for driving the sound generator based on the incoming call alert signal output from the mixing unit.

In accordance with this aspect of the invention, the incoming call alert sound comprising the advance incoming call alert sound and the main incoming call alert sound is produced through a single sound generator, thereby simplifying a construction.

The communication equipment unit according to yet another aspect of the invention further comprises schedule changing means for changing the setting of the operation schedule of the main incoming call alert signal output means and the advance incoming call alert signal, wherein the scheduling means allows the main incoming call alert signal output means and the advance incoming call alert signal output means to operate based on the operation schedule having the setting thereof changed by the schedule changing means.

In accordance with this aspect of the invention, the setting of the operation schedule can be changed and the pattern for producing the incoming call alert sound can be changed.

An incoming call alert method for a communication equipment unit producing an incoming call alert sound according to the present invention comprises the steps of: 1) outputting a main incoming call alert signal for sounding a main incoming call alert sound; 2) outputting an advance incoming call alert signal for sounding an advance incoming call alert sound different from the main incoming call alert sound; 3) allowing the steps 1) and 2) so that the main incoming call alert sound is produced after a predetermined period of time elapses since the advance incoming call alert sound is produced; and producing the incoming call alert sound based on the main incoming call alert signal and the advance incoming call alert signal.

In accordance with this aspect of the invention, the main incoming call alert sound is produced after a predetermined period of time elapses since the advance incoming call alert sound is produced. Therefore, the user is capable of recognizing the incoming call by the incoming call alert sound having a sound quality and a sound volume corresponding to the mode of usage. In comparison with a situation where a single incoming call alert sound is gradually increased in sound volume, discomfort felt by the user is reduced. Incoming call alert is implemented only by steps related to sound production. Therefore, in comparison with a case where an alert is given of an incoming call using vibration and then an incoming call alert sound is produced, the steps for incoming call alert is simplified.

### BRIEF DESCRIPTION OF THE DRAWINGS

FIG. 1 shows a construction according to the related art.

FIG. 2 shows a construction according to the related art.

FIG. 3 shows a construction according to first through third embodiments of the present invention.

FIG. 4 is a time chart showing an operation schedule according to the first embodiment.

FIG. 5 is a flowchart showing an operation according to the first embodiment.

FIG. 6 shows a construction according to a variation of the first embodiment.

FIG. 7 is a time chart showing an operation schedule according to the second embodiment.

FIG. 8 is a flowchart showing an operation according to the second embodiment.

FIG. 9 is a time chart showing an operation schedule according to the third embodiment.

FIG. 10 shows a construction according to a fourth embodiment of the present invention.

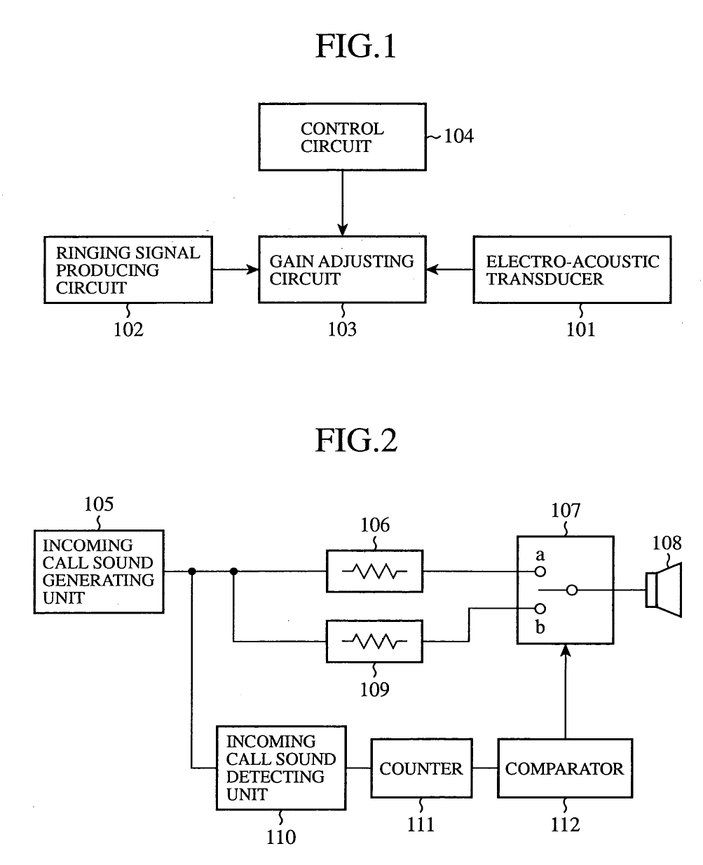

### BEST MODE FOR CARRYING OUT THE INVENTION

A description will now be given of the best mode for carrying out the present invention for a detailed explanation of the present invention, with reference to the attached drawings.

### First Embodiment

A description will now be given of the first embodiment.

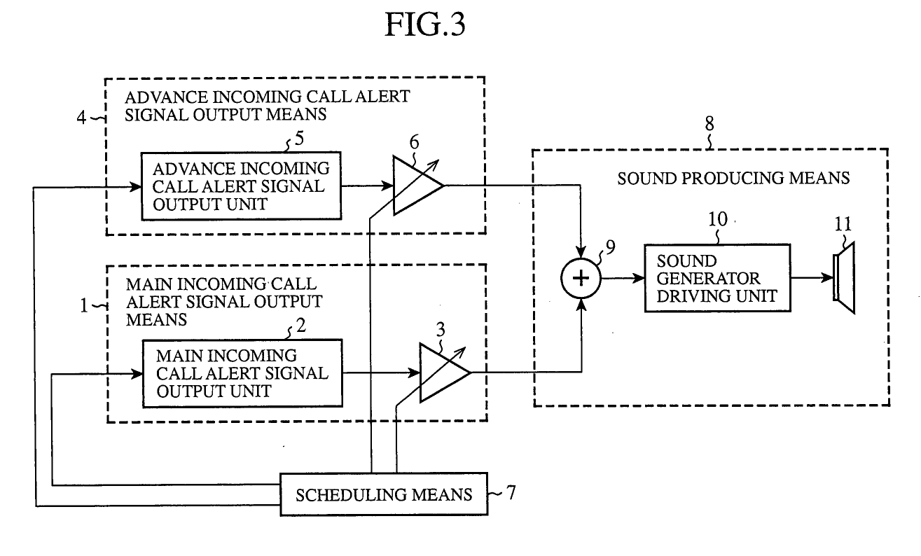

FIG. 3 shows prime constituents related to incoming call sound alert in a communication equipment unit according to the first embodiment essentially.

Referring to FIG. 3, a main incoming call alert signal output means 1 outputs a main incoming call alert signal for producing a main incoming call alert sound. The main incoming call alert signal output means 1 according to the first embodiment comprises a main incoming call alert signal output unit 2 for outputting the main incoming call alert signal and a main incoming call alert signal gain adjusting unit 3 for adjusting the gain of the main incoming call alert signal output from the main incoming call alert signal output unit 2.

An advance incoming call alert signal output means 4 outputs an advance incoming call alert signal for producing an advance incoming call alert sound produced in advance of the main incoming call alert sound and different from the main incoming call alert sound. The advance incoming call alert signal output means 4 according to the first embodiment comprises an advance incoming call alert signal output unit 5 for outputting the advance incoming call alert signal and an advance incoming call alert signal gain adjusting unit 6 for adjusting the gain of the advance incoming call alert signal output from the advance incoming call alert signal output unit 5.

The main incoming call alert signal output unit 2 according to the first embodiment outputs the main incoming call alert signal normalized to a predetermined signal level and is configured to be capable of producing or storing the main incoming call alert signal.

The main incoming call alert signal gain control unit 3 controls the gain of the main incoming call alert signal superimposed on the advance incoming call alert signal. In the first embodiment, the main incoming call alert signal gain control unit 3 is implemented by an amplifier.

The advance incoming call alert signal output unit 5 according to the first embodiment outputs the advance incoming call alert signal normalized to a predetermined signal level and is configured to be capable of producing or storing the advance incoming call alert signal.

The advance incoming call alert signal gain adjusting unit 6 according to the first embodiment adjusts the gain of the advance incoming call signal alert signal superimposed on the main incoming call alert signal. The advance incoming call alert signal gain adjusting unit 6 according to the first embodiment is implemented by an amplifier.

A scheduling means 7 allows the main incoming call alert signal output means 1 and the advance incoming call alert signal output means 4 to operate so that the main incoming call alert sound is produced after a predetermined period of time elapses since the advance incoming call alert sound is produced. The scheduling means 7 according to the first embodiment allows the main incoming call alert signal output unit 2, the main incoming call alert signal gain adjusting unit 3, the advance incoming call alert signal output unit 5 and the advance incoming call alert signal gain adjusting unit 6.

The scheduling means 7 according to the first embodiment operates based on a preset operation schedule so that the main incoming call alert sound is produced after a predetermined period of time elapses since the advance incoming call alert sound is produced. The operation schedule prescribes a timing for output of the main incoming call alert signal, a timing for output of the advance incoming call alert signal, the gain of the main incoming call alert signal corresponding to an elapsed time and the gain of the advance incoming call alert signal corresponding to an elapsed time. In the first embodiment, the gain of the main incoming call alert signal and the gain of the advance incoming call alert signal superimposed on each other are set.

The timing for output of the main incoming call alert signal and the timing for output of the advance incoming call alert signal are set based on the predetermined period of time mentioned above elapsed between production of the advance incoming call alert sound and production of the main incoming call alert sound. The gain is set based on a desired sound volume of the advance incoming call alert sound and the main incoming call alert sound corresponding to an elapsed time.

In the first embodiment, the scheduling means 7 outputs an output start signal to the main incoming call alert signal output unit 2 based on the operation schedule so that the main incoming call alert signal output unit 2 outputs the main incoming call alert signal. Subsequently, the scheduling means 7 outputs an output start signal to the advance incoming call alert signal output unit 5 at a timing preset based on the predetermined period of time mentioned above so that the advance incoming call alert signal output unit 5 outputs the advance incoming call alert signal. The scheduling means 7 also outputs amplification factor adjusting signals to the main incoming call alert signal gain adjusting unit 3 and the advance incoming call alert signal gain adjusting unit 6 so that the gain of the main incoming call alert signal and the gain of the advance incoming call alert signal superimposed on the main incoming call alert signal are set at a preset, desired level corresponding to an elapsed time.

A sound producing means 8 produces the incoming call alert sound based on the main incoming call alert signal output from the main incoming call alert signal output means 1 and the advance incoming call alert signal output from the advance incoming call alert signal output means 4. In the first embodiment, the sound producing means comprises a mixing unit 9, a sound generator driving unit 10 and a sound generator 11.

The mixing unit 9 superimposes the main incoming call alert signal output from the main incoming call alert signal output means 1 and the advance incoming call alert signal output from the advance incoming call alert signal output means 4 on each other so as to output the incoming call alert signal.

The sound generator driving unit 10 drives the sound generator 11 based on the incoming call alert signal output from the mixing unit 9.

The sound generator 11 is driven by the sound generator driving unit 10 so as to produce the incoming call sound. The sound generator 11 may be implemented by a speaker, a sounder, a bell or the like. A driving unit adapted for the type of sound generator is used as the sound generator driving unit 10. In the first embodiment, it is assumed that a speaker is used as the sound generator 11 and a signal amplifier capable of driving the speaker is used as the sound generator driving unit 10.

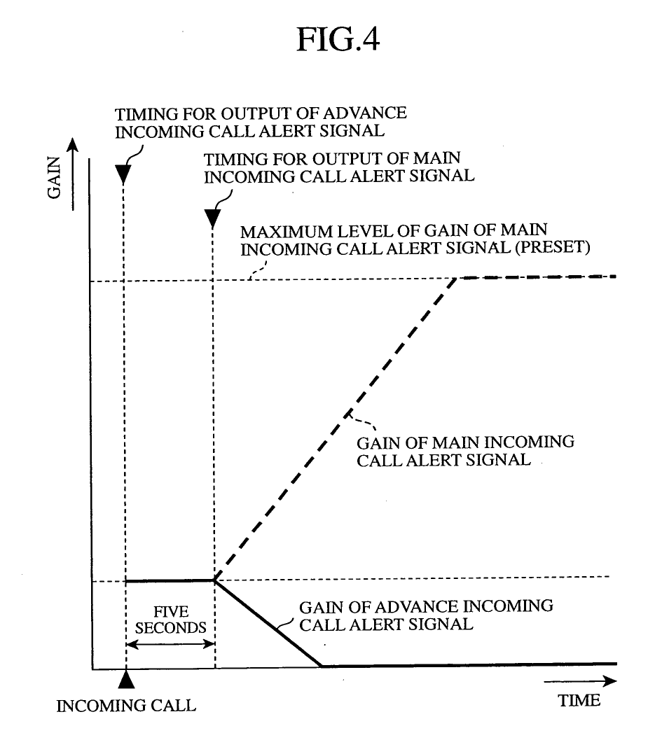

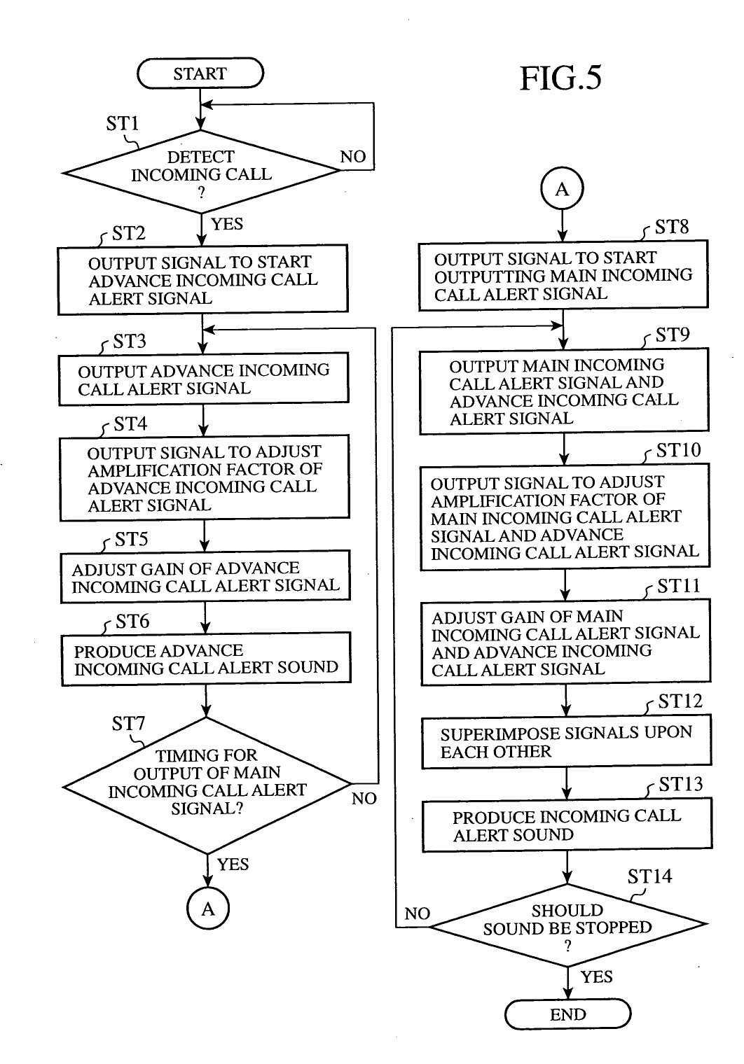

A description will now be given of the operation of the first embodiment with reference to FIGS. 3-5. FIG. 4 is a time chart showing how the operation schedule is set according to the first embodiment. FIG. 5 is a flowchart showing the flow of operation according to the first embodiment.

When a communication equipment unit detects an incoming call (Yes in step ST1), the scheduling means 7 outputs an output start signal to the advance incoming call alert signal output unit 5 based on the operation schedule shown in FIG. 4 (step ST2). Upon receiving the output start signal, the advance incoming call alert signal output unit outputs the advance incoming call alert signal (step ST3). The advance incoming call alert signal is to produce the advance incoming call alert sound in advance of the main incoming call alert sound. It is assumed here that a human voice message (for example, a message stating, “There is an incoming call.”) stored in the advance incoming call alert signal output unit 5 is used.

The scheduling means 7 outputs the amplification factor adjusting signal to the advance incoming call alert signal gain adjusting unit 6 based on the operation schedule (step ST4). Upon receiving the amplification adjusting signal, the advance incoming call alert signal gain adjusting unit 6 amplifies the advance incoming call alert signal output from the advance incoming call alert signal output unit 5, based on the amplification factor adjusting signal, so as to adjust the gain of the advance incoming call alert signal superimposed on the main incoming call alert signal (step ST5). The gain of the advance incoming call alert signal is set at a level for a small sound volume. For example, the gain is set so that the sound pressure in the ear is at a level of below 120 dBA when the sound generator 9 is placed firmly in the ear.

The advance incoming call alert signal having the gain thereof adjusted by the advance incoming call alert signal gain adjusting unit 6 is input to the mixing 9. The mixing unit 9 superimposes the advance incoming call alert signal and the main incoming call alert signal upon each other before outputting the incoming call alert signal. Since the main incoming call alert signal is yet produced at this timing, only the advance incoming call alert signal having the gain thereof adjusted is output and fed to the sound generator driving unit 10.

Upon receiving the incoming sound alert signal, the sound generator driving unit 10 drives the sound generator 11 based on the incoming call alert signal so that the sound generator 11 produces the incoming call alert sound (step ST6). As shown in FIG. 4, the operation schedule according to the first embodiment is set such that a period of 5 seconds elapses between the output of the advance incoming call alert signal and the output of the main incoming call alert signal. Accordingly, steps ST3 through ST7 are repeated for a period of 5 seconds (No in step ST7).

All this while, only the advance incoming call alert sound is produced. In this case, only the human voice message is produced at a relatively small sound volume. With this, the user of the communication equipment unit can recognize the incoming call.

When the timing for output of the main incoming call alert signal arrives, i.e. when a period of 5 seconds elapses (Yes in step ST7), the scheduling means 7 outputs the output start signal to the main incoming call alert signal output unit 2 based on the operation schedule shown in FIG. 4 (step ST8). Upon receiving the output start signal, the main incoming call alert signal output unit 2 outputs the main incoming call alert signal (step ST9). That is, in addition to the advance incoming call alert signal already output, the main incoming call alert signal is also output. The main incoming call alert signal is to produce the main incoming call alert sound. It is assumed here that a ringer sound created by the main incoming call alert signal output means 1 is used.

The scheduling means 7 outputs the amplification factor adjusting signal to the main incoming call alert signal gain adjusting unit 3 and the advance incoming call alert signal gain adjusting unit 6 based on the operation schedule (step ST10). Upon receiving the amplification factor adjusting signal, the main incoming call alert signal gain adjusting unit 3 amplifies the main incoming call alert signal output from the main incoming call alert signal output unit 2, based on the amplification factor adjusting signal, so as to adjust the gain of the main incoming call alert signal superimposed on the advance incoming call alert signal. The advance incoming call alert signal gain adjusting unit 6 amplifies the advance incoming call alert signal output from the advance incoming call alert signal output unit 5, based on the amplification factor adjusting signal, so as to adjust the gain of the advance incoming call alert signal superimposed on the main incoming call alert signal (step ST11). For example, the gain of the main incoming call alert signal and the gain of the advance incoming call alert signal are set at the identical level, as shown in FIG. 4.

The main incoming call alert signal having the gain thereof adjusted by the main incoming call alert signal gain adjusting unit 3 is fed to the mixing unit 9. The advance incoming call alert signal having the gain thereof adjusted by the advance incoming call alert signal gain adjusting unit 6 is also fed to the mixing unit 9. The mixing unit 9 superimposes the advance incoming call alert signal and the main incoming call alert signal upon each other (step ST12) so as to output a resultant signal as the incoming call alert signal.

When the incoming call alert signal is output from the mixing unit 9, the sound generator driving unit 10 drives the sound generator 11 based on the incoming call alert signal so that the sound generator 11 produces the incoming call alert sound (step ST13). Thereafter, steps ST9 through ST14 are repeated until a preset condition for halting the production of sound is met (No in step ST14). The preset condition may be a manual operation by the user in response to the incoming call or a lapse of a predetermined period of time.

Since the operation schedule according to the first embodiment is set as shown in FIG. 4, the gain of the main incoming call alert signal superimposed on the advance incoming call alert signal is increased with time until it reaches a preset maximum level. The gain of the advance incoming call alert signal superimposed on the main incoming call alert signal is attenuated gradually once the output of the main incoming call alert signal is started.

The mixing unit 9 superimposes upon each other the advance incoming call alert signal having the gain thereof adjusted to be gradually attenuated and the main incoming call alert signal having the gain thereof adjusted to be gradually increased. Therefore, while the signals remain being overlapped, the incoming call alert signal derived from a mixture of the signals produces the incoming call alert sound. Eventually, only the main incoming call alert sound is produced at a relatively large sound volume. With this, the user of the communication equipment unit can recognize the call at some point of time.

Thus, according to the first embodiment, when there is an incoming call, the advance incoming call alert sound, using a voice message which is relatively less uncomfortable to the user, is produced with a sound pressure at a level, for example, of below 120 dBA in the ear in which the sound generator 11 is placed firmly. The advance incoming call alert sound is seamlessly followed, after a predetermined period of time, by the main incoming call alert sound using a ringer sound at a preset sound volume which is gradually increased with time. Thus, the user holding the sound generator 11 in close contact with the ear is capable of recognizing the incoming call when the advance incoming call sound, which is less uncomfortable to the ear, is produced. Even if the user fails to recognize the incoming call when the advance incoming call alert sound is produced, the main incoming call alert sound different from the advance incoming call alert sound and overlapping the advance incoming call alert sound is produced at a preset sound volume which is gradually increased with time so that the user is capable of recognizing the incoming call. Thus, the user is capable of recognizing the incoming call by the incoming call alert sound having a sound quality and a sound volume corresponding to the mode of usage. In comparison with a situation where a single incoming call alert sound is gradually increased in sound volume, discomfort felt by the user is reduced.

Thus, in accordance with the communication equipment unit of the first embodiment, the main incoming call alert sound is produced after a predetermined period of time elapses since the production of the advance incoming call alert sound. Accordingly, the user is capable of recognizing the incoming call when the incoming call alert sound having a sound quality and a sound volume corresponding to the mode of usage is produced. In comparison with a situation where a single incoming call alert sound is produced, discomfort felt by the user is reduced.

In further accordance with the communication equipment unit of the first embodiment, incoming call alert is implemented only by a construction related to sound production. In comparison with a case where an alert is given of an incoming call using vibration and then an incoming call alert sound is produced, the construction for incoming call alert is simplified.

In further accordance with the communication equipment unit of the first embodiment, the main incoming call alert signal output means 1 comprises the main incoming call alert signal output unit 2 and the main incoming call alert signal gain adjusting unit 3. The advance incoming call alert output means 4 comprises the advance incoming call alert signal output unit 5 and the advance incoming call alert signal gain adjusting unit 6. The scheduling means 7 allows the main incoming call alert signal output unit 2, the main incoming call alert signal gain adjusting unit 3, the advance incoming call alert signal output unit 5 and the advance incoming call alert signal gain adjusting unit 5 to operate. Accordingly, the sound volume of the main incoming call alert sound and the advance incoming call alert sound is adjusted so as to reduce discomfort felt by the user.

In further accordance with the communication equipment unit of the first embodiment, the advance incoming call alert sound is produced at a relatively small sound volume. Therefore, an incoming call alert signal is prevented from being abruptly produced at a large sound volume, thereby reducing discomfort felt by the user.

In further accordance with the communication equipment unit of the first embodiment, the incoming call alert sound is produced based on the incoming call alert signal derived from superimposition of the main incoming call alert signal and the advance incoming call alert signal. The incoming call alert sound comprising the advance incoming call alert sound and the main incoming call alert sound is produced from a single sound generator, thereby simplifying a construction.

In further accordance with the first embodiment, the scheduling means 7 allows the main incoming call alert signal output unit 2, the main incoming call alert signal gain adjusting unit 3, the advance incoming call alert signal output unit 5 and the advance incoming call alert signal gain adjusting unit 6 to operate based on the operation schedule so that the main incoming call alert sound is produced after a predetermined period of time elapses since the advance incoming call alert sound is produced. Accordingly, by changing the setting of the operation schedule, the incoming call alert sound is produced using a desired pattern.

A description of the first embodiment is given assuming that mixing unit 9, the sound generator driving unit 10 and the sound generator 11 constitute the sound producing means 8. Alternatively, two sound generator driving units and two sounding bodies may constitute the sound producing means 8. In this case, the number of constituting elements increases in comparison with the first embodiment. Despite this increase, it is ensured that the main incoming call alert sound is produced after a predetermined period of time since the advance incoming call alert sound is produced. Accordingly, the user is capable of recognizing the incoming call when the incoming call alert sound having a sound quality and a sound volume corresponding to the mode of usage is produced. In comparison with a situation where a single incoming call alert sound is produced, discomfort felt by the user is reduced.

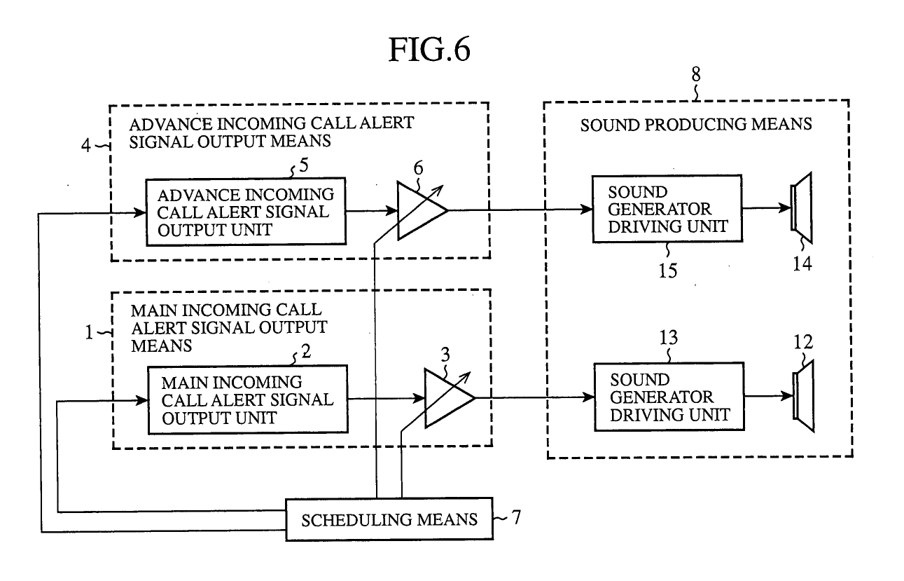

FIG. 6 shows a construction where two sound generator driving units and two sounding bodies constitute the sound producing means 8. Those components that are identical with or corresponding to the components of FIG. 3 are designated by the same reference numerals and the description thereof is omitted. A sound generator 12 produces the main incoming call alert sound. A sound generator driving unit 13 drives the sound generator 12 based on the main incoming call alert signal output from the main incoming call alert signal gain adjusting unit 3 and having the gain thereof adjusted. A sound generator 14 produces the advance incoming call alert sound. A sound generator driving unit 15 drives the sound generator 14 based on the advance incoming call alert signal output from the advance incoming call alert signal gain adjusting unit 6 and having the gain thereof adjusted.

With this construction, when there is an incoming call, the main incoming call alert signal output unit 2, the main incoming call alert signal gain adjusting unit 3, the advance incoming call alert signal output unit 5, the advance incoming call alert signal gain adjusting unit 6 and the scheduling means 7 operate in the same manner as these components operate according to the first embodiment. After the advance incoming call alert sound is produced from the sound generator 14, the main incoming call alert sound is produced from the sound generator 12.

### Second Embodiment

A description will be given of the second embodiment.

In the first embodiment, the scheduling means outputs an output start signal to the main incoming call alert signal output unit and subsequently outputs an output start signal to the advance incoming call alert signal output unit at a timing preset based on a predetermined period of time. A description will now be given of the second embodiment in which the output start signal is simultaneously output to the main incoming call alert signal output unit and the advance incoming call alert signal output unit.

The main construction according to the second embodiment related to incoming call alert in a communication equipment unit is as shown in FIG. 3. Since the construction remain unchanged, the description thereof is omitted.

A difference in the operation schedule is that the main incoming call alert signal and the advance incoming call alert signal are timed to be output simultaneously. The gain is set based on a desired sound volume of the advance incoming call alert sound and the main incoming call alert sound corresponding to an elapsed time.

The scheduling means 7 outputs the output start signal simultaneously to the main incoming call alert signal output unit 2 and to the advance incoming call alert signal output unit 5, based on the operation schedule. As a result of this, the main incoming call alert signal is output from the main incoming call alert signal output unit 2 concurrently with the output of the advance incoming call alert signal from the advance incoming call alert signal output unit 5. The scheduling means 7 also outputs the amplification factor adjusting signal to the main incoming call alert signal gain adjusting unit 3 and the advance incoming call alert signal gain adjusting unit 6 so that the gain of the main incoming call alert signal and the gain of the advance incoming call alert signal superimposed on each other are set at a preset, desired level corresponding to an elapsed time.

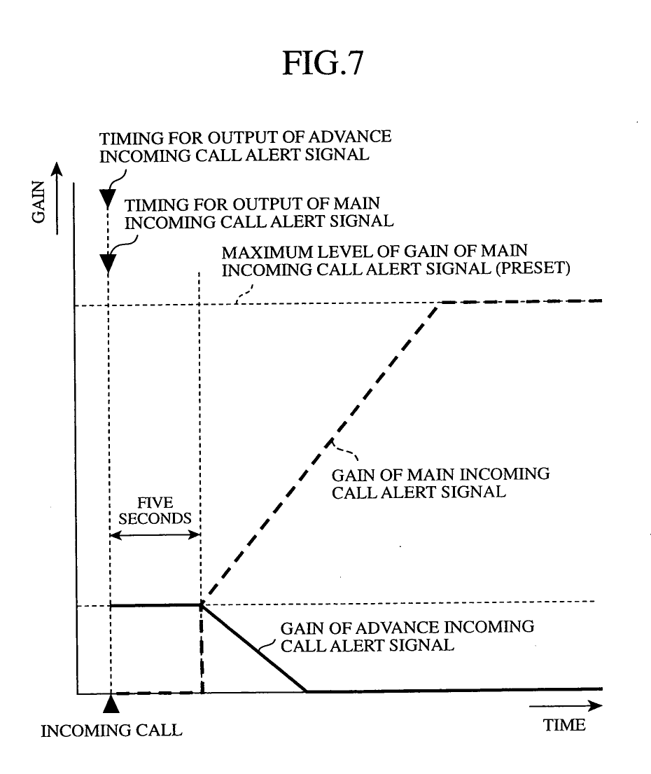

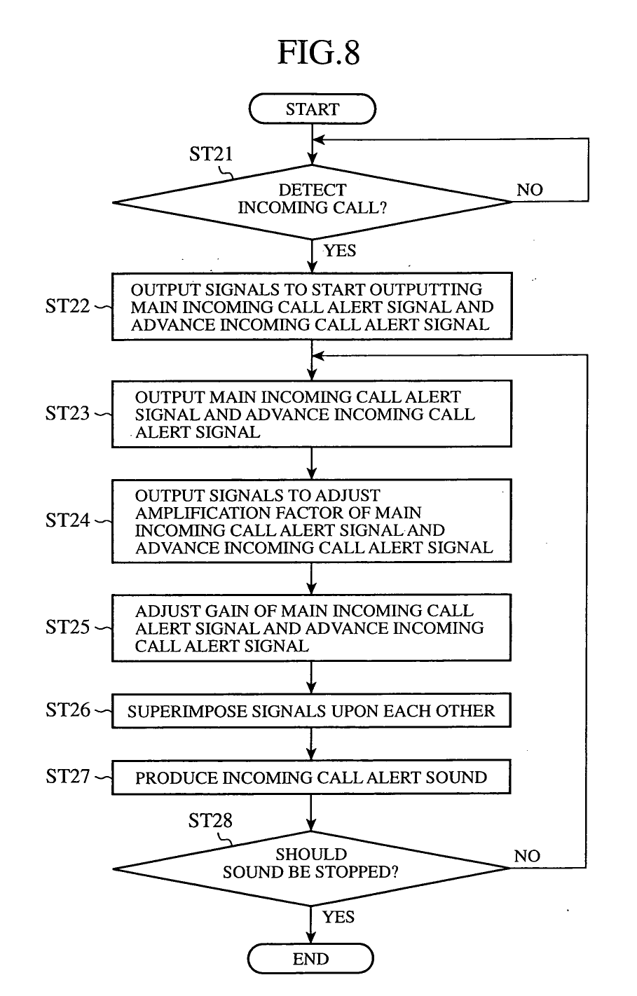

A description will now be given of the second embodiment using FIG. 3, FIG. 7 and FIG. 8. FIG. 7 is a time chart showing how the operation schedule is set according to the second embodiment. FIG. 8 is a flowchart showing the flow of operation according to the second embodiment.

When a communication equipment unit detects an incoming call (Yes in step ST21), the scheduling means 7 outputs the output start signal to the main incoming call alert signal output unit 2 and the advance incoming call alert signal output unit 5, based on the operation schedule shown in FIG. 7 (step ST22). Upon receiving the output start signal, the main incoming call alert signal output unit 2 outputs the main incoming call alert signal and the advance incoming call alert signal output unit 5 outputs the advance incoming call alert signal (step ST23).

The main incoming call alert signal is to produce the main incoming call alert sound. It is assumed here that a ringer sound created by the main incoming call alert signal output unit 2 is used. The advance incoming call alert signal is to produce the advance incoming call alert sound in advance of the main incoming call alert sound. It is assumed here that a human voice message (for example, a message stating, “There is an incoming call.”) stored in the advance incoming call alert signal output unit 5 is used.

The scheduling means 7 outputs the amplification factor adjusting signal to the main incoming call alert signal gain adjusting unit 3 and outputs the amplification factor adjusting signal to the advance incoming call alert signal gain adjusting unit 6, based on the operation schedule (step ST24).

Upon receiving the amplification adjusting signal, the main incoming call alert signal gain adjusting unit 3 amplifies the main incoming call alert signal output from the main incoming call alert signal output unit 2 so as to adjust the gain of the main incoming call alert signal superimposed on the advance incoming call alert signal. The advance incoming call alert signal gain adjusting unit 6 amplifies the advance incoming call alert signal output from the advance incoming call alert signal output unit 5, based on the amplification factor adjusting signal, so as to adjust the gain of the advance incoming call alert signal superimposed on the main incoming call alert signal (step ST25).

At this point, the gain of the main incoming call alert signal is set at “0”. The gain of the advance incoming call alert signal is set at a level for a small sound volume. For example, the gain is set so that the sound pressure in the ear is at a level of below 120 dBA when the sound generator 11 is placed firmly in the ear.

The main incoming call alert signal having the gain thereof adjusted by the main incoming call alert signal gain adjusting unit 3 is input to the mixing 9. The advance incoming call alert signal having the gain thereof adjusted by the advance incoming call alert signal gain adjusting unit 6 is also input to the mixing 9. The mixing unit 9 superimposes the advance incoming call alert signal and the main incoming call alert signal upon each other (step ST26) so as to output a resultant signal as the incoming call alert signal.

When the incoming call alert signal is output from the mixing unit 9, the sound generator driving unit 10 drives the sound generator 11 based on the incoming call alert signal so that the sound generator 11 produces the incoming call alert sound (step ST27). Thereafter, steps ST23 through ST28 are repeated until a preset condition for halting the production of sound is met (No in step ST28). The preset condition may be an manual operation by the user in response to the incoming call or a lapse of a predetermined period of time.

Since the operation schedule according to the second embodiment is set as shown in FIG. 7, the gain of the main incoming call alert signal superimposed on the advance incoming call alert signal is initially set at “0” for 5 seconds and is increased with time until it reaches a preset maximum level. The gain of the advance incoming call alert signal superimposed on the main incoming call alert signal is set at a level for a small sound volume and is attenuated gradually with time.

Since the gain of the main incoming call alert signal superimposed on the advance incoming call alert signal is set at “0” initially, only the advance incoming call alert sound is produced. The mixing unit 9 superimposes upon each other the advance incoming call alert signal having the gain thereof adjusted to be gradually attenuated and the main incoming call alert signal having the gain thereof adjusted to be gradually increased. Therefore, while the signals remain being overlapped, the incoming call alert signal derived from a mixture of the signals produces the incoming call alert sound. Eventually, only the main incoming call alert sound is produced at a relatively large sound volume.

Thus, according to the second embodiment, when there is an incoming call, the advance incoming call alert sound, using a voice message which is relatively less uncomfortable to the user, is produced with a sound pressure at a level, for example, of below 120 dBA in the ear in which the sound generator 11 is placed firmly. The advance incoming call alert sound is seamlessly followed, after a predetermined period of time, by the main incoming call alert sound using a ringer sound at a preset sound volume which is gradually increased with time. Thus, the user holding the sound generator 11 in close contact with the ear is capable of recognizing the incoming call when the advance incoming call sound, which is less uncomfortable to the ear, is produced. Even if the user fails to recognize the incoming call when the advance incoming call alert sound is produced, the main incoming call alert sound different from the advance incoming call alert sound and overlapping the advance incoming call alert sound is produced at a preset sound volume which is gradually increased with time so that the user is capable of recognizing the incoming call. Thus, the user is capable of recognizing the incoming call by the incoming call alert sound having a sound quality and a sound volume corresponding to the mode of usage. In comparison with a situation where a single incoming call alert sound is gradually increased in sound volume, discomfort felt by the user is reduced.

Thus, according to the second embodiment, the same advantage as that of the first embodiment is available. In addition, since the main incoming call alert sound is output concurrently with the advance incoming call alert signal, the operation schedule can be shared by the main incoming call alert signal and the advance incoming call alert signal.

While the construction shown in FIG. 3 is assumed in the second embodiment, the construction shown in FIG. 6 may alternatively be employed. In this case, more constituting elements are needed than the second embodiment described above. Still, the main incoming call alert sound is produced after a predetermined period of time elapses since the production of the advance incoming call alert sound. Accordingly, the user is capable of recognizing the incoming call by the incoming call alert sound having a sound quality and a sound volume corresponding to the mode of usage. In comparison with a situation where a single incoming call alert sound is produced, discomfort felt by the user is reduced.

### Third Embodiment

A description will now be given of the third embodiment.

In the foregoing embodiments, a description is given of a situation where, in response to an incoming call, only the advance incoming call alert sound at a relatively small sound volume is produced initially. Subsequently, the main incoming call alert sound grows in sound volume, and the advance incoming call alert sound fades out. The third embodiment employs another pattern for sounding an incoming call alert sound.

A main construction related to incoming call alert in a communication equipment unit according to the third embodiment is shown in FIG. 3. Since the construction is the same as that of the first embodiment, the description thereof is omitted.

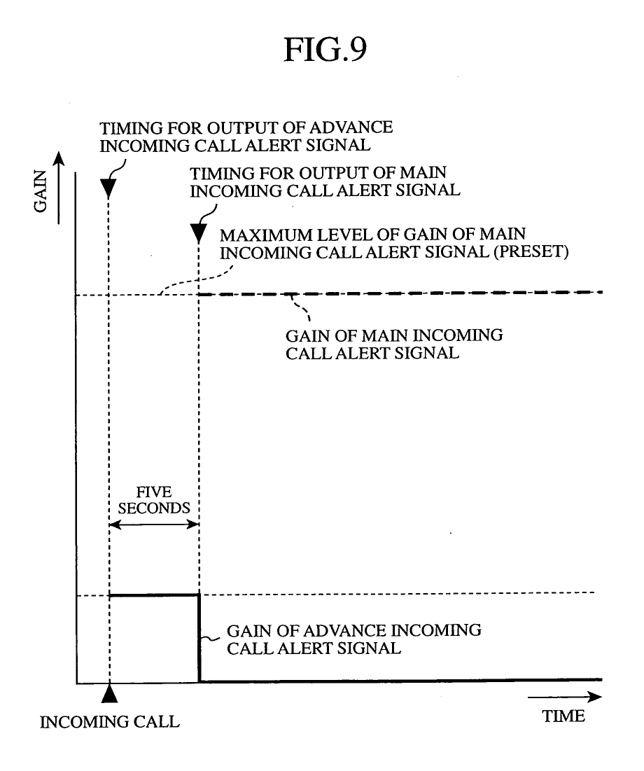

A difference is that the operation schedule is set as shown in FIG. 9.

In the third embodiment, the communication equipment unit operates as shown in FIG. 5 illustrating the operation according to the first embodiment. Since the operation schedule is set as shown in FIG. 9, the advance incoming call alert sound at a relatively small sound volume is produced in response to an incoming call. After a predetermined period of time elapses, the main incoming call alert sound is produced at a predetermined sound volume. With this, the user holding the sound generator 11 in close contact with the ear is capable of recognizing the incoming call when the advance incoming call sound, which is relatively less uncomfortable to the user, is produced at a relatively small sound volume. Even if the user fails to recognize the incoming call when the advance incoming call alert sound is produced, recognition is ensured because the main incoming call alert sound different from the advance incoming call alert sound is produced at a relatively large, constant sound volume from the beginning.

Since the scheduling means 7 operates based on the operation schedule, any desired pattern for producing an incoming call alert sound may be used only by changing the operation schedule. By using the operation schedule shown in FIG. 9, the pattern is set such that, subsequent to the advance incoming call alert sound, the main incoming call alert sound is produced at a relatively large, constant sound volume from the beginning.

With this pattern, the user is capable of recognizing the incoming call by the incoming call alert sound having a sound quality and a sound volume corresponding to the mode of usage. That is, music may be used as the main incoming call alert sound, allowing the user to recognize the main incoming call alert sound at a relatively large, constant volume from the beginning. Moreover, since the advance incoming call alert sound is produced for a predetermined period of time in advance of the main incoming call alert sound, the user holding the sound generator 11 in close contact with the ear is capable of recognizing the incoming call when the advance incoming call sound, which is less uncomfortable to the ear, is produced at a relatively small sound volume. An incoming call alert signal is prevented from being abruptly produced at a large sound volume, thereby reducing discomfort felt by the user.

Thus, according to the third embodiment, the same advantage as that of the first embodiment is available. The operation schedule is such that the gain of the advance incoming call alert signal immediately following the incoming call is set at a level for a relatively small sound volume, the gain of the main incoming call alert signal is set at “0” for the same period and the gain of the main incoming call alert signal is set at a constant level for a relatively large, normal sound volume once the main incoming call alert signal is output. Therefore, the user is capable of recognizing the main incoming call alert sound at a relatively large, constant sound volume from the beginning. Moreover, an incoming call alert signal is prevented from being abruptly produced at a large sound volume. The user is capable of recognizing the incoming call by the incoming call alert sound having a sound quality and a sound volume corresponding to the mode of usage. In comparison with a situation where a single incoming call alert sound is produced, discomfort felt by the user is reduced.

### Fourth Embodiment

A description will now be given of the fourth embodiment.

In the foregoing embodiments, the scheduling means is described as operating based on the preset operation schedule. The fourth embodiment described hereinafter allows the operation schedule to be changed.

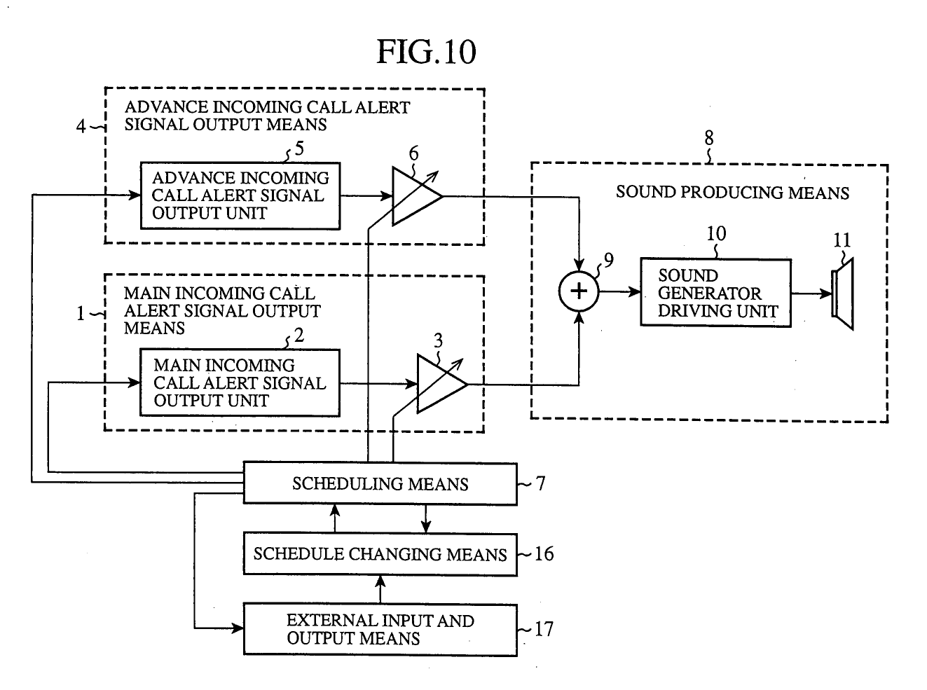

FIG. 10 shows a main construction related incoming call alert in a communication equipment unit according to the fourth embodiment. Those components that are identical with or corresponding to the components of FIG. 3 are designated by the same reference numerals and the description thereof is omitted. A difference is that the scheduling means 7 is adapted to store operation schedules. Each of the stored operation schedules designates the timing for outputting the main incoming call alert signal, the timing for outputting the advance incoming call alert signal, the gain of the main incoming call alert signal corresponding to an elapsed time and the gain of the advance incoming call alert signal corresponding to an elapsed time, so that the main incoming call alert sound is produced after a predetermined period of time has elapsed since the production of the advance incoming call alert sound. When the operation schedule is changed, the scheduling means 7 operates based on the operation schedule after the change. In the fourth embodiment, the gain of the main incoming call alert signal and the gain of the advance incoming call alert signal superimposed upon each other are set.

A schedule changing means 16 changes the setting of the operation schedule controlling the main incoming call alert signal outputting means 1 and the advance incoming call alert signal outputting means 4. In the fourth embodiment, the operation schedule, in which the timing for outputting the main incoming call alert signal, the timing for outputting the advance incoming call alert signal, the gain of the main incoming call alert signal corresponding to an elapsed time, the gain of the advance incoming call alert signal corresponding to an elapsed time are set, is changed. An external input and output means 17 displays the setting of the operation schedule to the user and accepts a command operation by the user.

A description will now be given of the operation for changing the setting of the operation schedule.

For example, when there is a request for changing the operation schedule from the user, the external input and output means 17 displays the setting of the operation schedule stored in the scheduling means 7. When the user performs a command operation for changing the setting, using a key input, a voiced input or the like, the external input and output means 17 accepts the command operation and outputs the same to the scheduling changing means 16.

The schedule changing means 16 changes the setting of the operation schedule in accordance with the command operation and stores the setting thus changed in the scheduling means 7. Subsequently, the scheduling means 7 operates based on the operation schedule after the change. Thus, the setting of the operation schedule can be changed in accordance with the user's preference so that the incoming call alert sound is produced with a desired pattern.

Thus, according to the fourth embodiment, the schedule changing means for changing the setting of the operation schedule is provided. Accordingly, the setting of the operation schedule can be changed and the pattern for sounding the incoming call alert sound can be changed.

Since the communication equipment unit according to the fourth embodiment is provided with an external input and output means that displays the setting of the operation schedule to the user and accepts a command operation by the user, the user is capable of confirming the setting of the operation schedule and changing a pattern for producing the incoming call alert sound to the one least uncomfortable to the user.

The description of the fourth embodiment assumes that there is provided external input and output means that allows the setting of the operation schedule to be changed responsive to the user's command operation. Alternatively, the schedule changing means may change the setting of the operation schedule based on an operation schedule changing signal received from another communication equipment unit. In this case, the setting of the operation schedule can be changed by another communication equipment unit without the external input and output means.

The present invention is not limited to the above-described embodiments, and variations and modifications may be made without departing from the scope of the present invention.

### INDUSTRIAL APPLICABILITY

As has been described, the communication equipment unit according to the invention is suitably used for reducing discomfort at an incoming call alert.

1. A communication equipment unit producing an incoming call alert sound comprising:
main incoming call alert signal output means for outputting a main incoming call alert signal for sounding a main incoming call alert sound;
advance incoming call alert signal output means for outputting an advance incoming call alert signal for sounding an advance incoming call alert sound which is different from said main incoming call alert signal output means;
scheduling means for allowing said main incoming call alert signal output means and said advance incoming call alert signal output means to operate so that the main incoming call alert sound is produced after a predetermined period of time elapses since the advance incoming call alert sound is produced; and
sound production means for producing the incoming call alert sound based on the main incoming call alert signal and the advance incoming call alert signal.

2. The communication equipment unit according to claim 1, wherein
said main incoming call alert signal output means comprises a main incoming call alert signal output unit for outputting the main incoming call alert signal and a main incoming call alert signal gain adjusting unit for adjusting a gain of the main incoming call alert signal,
said advance incoming call alert signal output means comprises an advance incoming call alert signal output unit for outputting the advance incoming call alert signal and an advance incoming call alert signal gain adjusting unit for adjusting a gain of the advance incoming call alert signal, and
said scheduling means allows said main incoming call alert signal output unit, said main incoming call alert signal gain adjusting unit, said advance incoming call alert signal output unit and said advance incoming call alert signal gain adjusting unit to operate.

3. The communication equipment unit according to claim 2, wherein said scheduling means allows said advance incoming call alert signal gain adjusting unit to operate such that the advance incoming call alert sound is produced at a small volume.

4. The communication equipment unit according to claim 1, wherein said sound producing means comprises a sound generator for producing an incoming call alert sound, a mixing unit for superimposing the main incoming call alert signal and the advance incoming call alert signal so as to output an incoming call alert signal, and a sound generator driving unit for driving said sound generator based on the incoming call alert signal output from said mixing unit.

5. The communication equipment unit according to claim 2, wherein said sound producing means comprises a sound generator for producing an incoming call alert sound, a mixing unit for superimposing the main incoming call alert signal and the advance incoming call alert signal upon each other so as to output an incoming call alert signal, and a sound generator driving unit for driving said sound generator based on the incoming call alert signal output from said mixing unit.

6. The communication equipment unit according to claim 3, wherein said sound producing means comprises a sound generator for producing an incoming call alert sound, a mixing unit for superimposing the main incoming call alert signal and the advance incoming call alert signal upon each other so as to output an incoming call alert signal, and a sound generator driving unit for driving said sound generator based on the incoming call alert signal output from said mixing unit.

7. The communication equipment unit according to claim 1, further comprising schedule changing means for changing the setting of the operation schedule of said main incoming call alert signal output means and said advance incoming call alert signal, wherein
said scheduling means allows said main incoming call alert signal output means and said advance incoming call alert signal output means to operate based on the operation schedule having the setting thereof changed by said schedule changing means.

8. The communication equipment unit according to claim 2, further comprising schedule changing means for changing the setting of the operation schedule of said main incoming call alert signal output means and said advance incoming call alert signal, wherein
said scheduling means allows said main incoming call alert signal output means and said advance incoming call alert signal output means to operate based on the operation schedule having the setting thereof changed by said schedule changing means.

9. The communication equipment unit according to claim 3, further comprising schedule changing means for changing the setting of the operation schedule of said main incoming call alert signal output means and said advance incoming call alert signal, wherein
said scheduling means allows said main incoming call alert signal output means and said advance incoming call alert signal output means to operate based on the operation schedule having the setting thereof changed by said schedule changing means.

10. The communication equipment unit according to claim 4, further comprising schedule changing means for changing the setting of the operation schedule of said main incoming call alert signal output means and said advance incoming call alert signal, wherein
said scheduling means allows said main incoming call alert signal output means and said advance incoming call alert signal output means to operate based on the operation schedule having the setting thereof changed by said schedule changing means.

11. The communication equipment unit according to claim 5, further comprising schedule changing means for changing the setting of the operation schedule of said main incoming call alert signal output means and said advance incoming call alert signal, wherein
said scheduling means allows said main incoming call alert signal output means and said advance incoming call alert signal output means to operate based on the operation schedule having the setting thereof changed by said schedule changing means.

12. The communication equipment unit according to claim 6, further comprising schedule changing means for changing the setting of the operation schedule of said main incoming call alert signal output means and said advance incoming call alert signal, wherein
said scheduling means allows said main incoming call alert signal output means and said advance incoming call alert signal output means to operate based on the operation schedule having the setting thereof changed by said schedule changing means.

13. An incoming call alert method for a communication equipment unit producing an incoming call alert sound comprising the steps of:
1) outputting a main incoming call alert signal for sounding a main incoming call alert sound which is a major part of the incoming call alert sound;
2) outputting an advance incoming call alert signal for sounding an advance incoming call alert sound different from the main incoming call alert sound;
3) allowing said steps 1) and 2) so that the main incoming call alert sound is produced after a predetermined period of time elapses since the advance incoming call alert sound is produced; and
producing the incoming call alert sound based on the main incoming call alert signal and the advance incoming call alert signal.
